(19) United States
(12) Patent Application Publication
(10) Pub. No.: US 2013/0209984 A1
(43) Pub. Date: Aug. 15, 2013

(54) METHODS AND SYSTEMS FOR ASSISTING IN TERMINAL LIFE DECISIONS

(71) Applicant: JOHN F. MACEK LLC, (US)

(72) Inventor: JOHN F. MACEK, Janesville, WI (US)

(73) Assignee: JOHN F. MACEK LLC, Janesville, WI (US)

(21) Appl. No.: 13/736,393

(22) Filed: Jan. 8, 2013

Related U.S. Application Data
(60) Provisional application No. 61/598,688, filed on Feb. 14, 2012.

(51) Int. Cl. G06Q 50/22; G09B 3/00

(52) U.S. Cl. CPC G06Q 50/22; G09B 3/00
USPC 434/362; 434/322

(57) ABSTRACT

Methods and systems for assisting in terminal life decisions. The methods and systems include a guide completed by a user which will instruct selected people to make decisions on behalf of the user.

### RELATED APPLICATIONS

This application claims the benefit of co-pending provisional application Ser. No. 61/598,688 filed 14 Feb. 2012.

### BACKGROUND OF THE INVENTION

The present invention relates to systems and methods for assisting a person in making life decisions, and, more particularly, for assisting in making decisions at or near the end of the person's life.

98% of individuals, including members of your workforce, arrive at hospitals in near-death condition with no living will on file. Most of the time, they have never discussed the subject with family or friends. Without specific directives, the physician has only one option: do everything possible to keep the patient alive. The resulting high-cost, high-tech procedures are a big factor in increasing the cost of employer health plans. Additionally, according to an episode of “Money & Medicine” premiered on Sep. 25, 2012 and available at www.pbs.org/programs/money-medicine/, approximately 30%, or roughly $800 Billion, of health care in the United States is devoted to unnecessary services. Furthermore, nearly one-third of health care dollars spent are in the last two years of life.

When the end of life is nearing, some people want everything possible done to extend their life, regardless of outcome. However, many do not understand that some life sustaining measures only prolong death and may actually increase suffering. Moreover, the third leading cause of death in the United States is the combination of medical errors, drug interactions, and hospital acquired infections. Currently, there is a disconnect in the social conscious between what clinicians are capable of doing, and what they can do that will actually be beneficial to a patient. On the other hand, others feel strongly about potential outcomes and want to establish what they consider acceptable. However, if these persons do not have a living will on file, and are unable to speak for themselves, they lose control over their health care decisions and, as mentioned earlier, doctors will do everything possible to sustain life. By offering employees a simple way of recording their wishes, employer health plans could save hundreds of thousands of dollars now spent for procedures some may not have wanted.

Giving people control over their end-of-life care is good for everyone. 1) The patient gets what they want. 2) Physicians can comfortably proceed to meet those wants. 3) Families are spared the terrible burden of making life and death decisions and can become partners with the physician in meeting a loved one's wishes.

Employer health plans now pay for weeks and months of hospital expenses while physicians and families struggle to discern a loved one's wants and comfortably conclude when it's time to let nature take its course. Extended hospital stays for unwanted procedures add significantly to employer health care premiums, not to mention the needless suffering experienced by the patient.

Furthermore, the decision making process of a person under duress is likely significantly impaired. It is generally preferred to make end-of-life decisions in a calm and reasoned mental state. Doing so allows a person to evaluate one's beliefs and consider all possible outcomes. Currently, living wills and Power of Attorney documents provide little help in this area as they do not approach this difficult subject matter in a patient oriented manner. As can be seen, they leave much to be desired as they merely scratch the surface as to potential situations like mental capacity, life sustainment, and the roles of third party decision makers who have little or no knowledge of the patient they represent.

Accordingly, there is a long-felt need for systems and methods to assist in making end-of-life decisions.

### SUMMARY OF THE INVENTION

The present invention is designed to help individuals express their feelings about a topic they prefer not to think about at all. It uses proven psychological techniques that allow an individual to express their thoughts and feelings about a full range of important end-of-life issues with greater comfort. It further provides a methodology for a patient to make decisions based on preferences regarding potential outcomes ahead of time in order to eliminate guess work by doctors and agents as to patient wishes and desires.

The user chooses two (or more) confidantes to become their spokespersons. They give a copy of the completed document to these trusted spokespersons with whom they discuss their thinking. Using discussion in addition to written word provides very clear guidelines about one's wants. Introducing a dialogue process in addition to the written word is an important feature that distinguishes the present invention from other living wills and similar documents.

The present invention also is directed towards systems for carrying out these methods and processes.

### BRIEF DESCRIPTION OF THE DRAWINGS

FIG. 1 represents a user completing a guide according to the present invention.

FIG. 2 represents the user distributing the completed guide to other individuals that the user will rely upon to make decisions for the user.

FIG. 3 represents the user discussing the completed guide to the other individuals shown in FIG. 2.

FIG. 4 represents one form into which the present invention may be incorporated, e.g. a computer readable disk, for storing the guide of the present invention.

FIG. 5 represents another form into which the present invention may be incorporated, e.g. a handheld device, for storing the guide of the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

The present invention assists a user in determining that user's best course of action should the user ever become terminally ill or mentally incapacitated and not be able to make decisions for oneself. For many people, discussing end of life decisions is not an easy task. The present invention provides a more comfortable and less stressful way to express personal thoughts and desires about this difficult topic. One of these methods is emotional distancing, or desentization. Users are given a series of statements for which the user indicates her level of agreement or disagreement with each statement. The statements are cast from a more personal perspective including statements on potential effects on family members. Additionally, some statements cover a topic in more general terms and some in more specific terms. This allows the user to process the difficult subject matter in a more thoughtful way; to see the big picture and also the minutiae.

Some of the more critical areas may be approached by using multiple statements, employing opposing language so that the responses can be validated. Opposing language can be considered as language that will present a statement in two different ways, wherein the response by the user would have competing responses. For example, a statement regarding a patient's preferred level of cognitive ability in order to maintain life support may provoke a positive response in one instance, but when asked in a different way with different parameters, may provoke a response in the negative. This provides a deeper understanding of the patient's wishes because important end-of-life situations are approached from multiple angles.

Additionally, in the present embodiment the invention incorporates the Likert scale, a widely used tool to indicate degree of feeling or investment. The invention is not limited to the Likert scale; any scale capable of assessing a user's relative value of agreement may be used. The use of statements in combination with a scaled response distances the user from the difficult subject matter and allows him to focus more on his attitude and values about end-of-life and continuing-life choices. Furthermore, users may circle a level of agreement/disagreement and enter additional clarifying information in a comments section, thus providing additional information or instruction to further flush out the user's intentions. In other areas which usually involve very specific wants, like funeral arrangements, users are asked to clarify any specifics.

Moreover, because it is impossible to prepare for every possible situation, the invention defers decisions to third parties who can apply the broad ranging information supplied by the user's ratings and comments of the statements as guidelines to make well informed decisions in real-time situations. All in all, the variances in responses to the statements provide a very comprehensive profile of the user's overall values and wishes, thus giving all of the agents and physicians a high level of confidence that they understand, and will properly meet, the user's intended desires at a time when the user is no longer able to communicate.

In addition to supplying insights as provoked by the statements, the user also discusses her ratings and comments with her team of at least two agents in accordance with the present invention. Discussing the user ratings and comments allows the agents to witness the user's voice inflections, facial cues, and any hesitant or emphatic reactions. This intangible information provides even further insight into the user's wishes, and arms the agents with knowledge that will help them make decisions more tailored to the user. Moreover, the open discourse format provides an opportunity for agents to inquire further if they feel more information is necessary.

Speaking to the agents at one time in one place also allows everybody to compare notes to assure that everyone is accurately interpreting the user's wishes. However, this part may be carried out remotely through video conferencing as long as the agents are able to witness both verbal and non-verbal cues. Furthermore, by setting the stage for ongoing dialogue between the individual and decision makers, the user can readily keep decision makers updated on any changes in thinking. When these exchanges occur, communication goes well beyond words. Tone of voice, choice of words and intensity of feeling about changes in thinking add an even greater dimension to understanding the user's thoughts and feelings.

Traditional living wills are a snap shot of an individual's thinking at the time they are written. They can gather dust for decades and may not reflect the person's current thinking. Additionally, medical treatment is constantly evolving and a living will may not provide the guidance necessary to make decisions based on new treatments. However, the present invention's focus on the user's preferences, dependent upon potential outcomes, provides greater insight as to how the user would act in any given situation, regardless of new treatments. The present invention is “state of the art.” It leads the field by creating a more valid approach to living wills.

The use of surrogate decision makers following guidelines set by the patient is increasingly accepted as a best practice standard. It assures that patient wishes are well understood and met.

The use of surrogate decision makers also benefits not only the user, but also the user's family members. For example:

1. With clear guidelines in place, families and loved ones are spared the agony and guilt of trying to guess the patient's wants and make medical decisions.

2. Instead of feeling at a loss, families have a road map for assuring that their loved one's wishes are met. While the pain of loss will not go away, families are more at peace having been helpers to the end.

3. Starting the conversation in advance allows families to more readily accept the inevitable. They can feel freer to use hospice care, an approach that is much less costly and is shown to yield survival rates equal to those receiving active hospital treatment. Hospice services help the dying person and their families share precious moments, making both more prepared for death.

The present invention also provides financial benefits for an employer or insurance provider. For example:

1. The employer or insurance provider will have a standard procedure that can be used for all employees to determine how they wish to deal with end-of-life issues.

2. Generally, when people discuss end-of-life issues at a time when there is no urgency, people tend to prefer more conservative care. Conservative care results in lower health care costs, and when this preference is communicated through a mechanism like the present invention, it means that employers or insurance providers, over time, can save on health care costs, while still carrying out the wishes and requests of the user.

3. The present method also provides indirect advantages for an employer. When families become enablers who help their loved one achieve their wishes, doing so brings solace to families and allows more rapid closure. When a company's employees achieve more rapid closure, they are more prepared to return to full productivity.

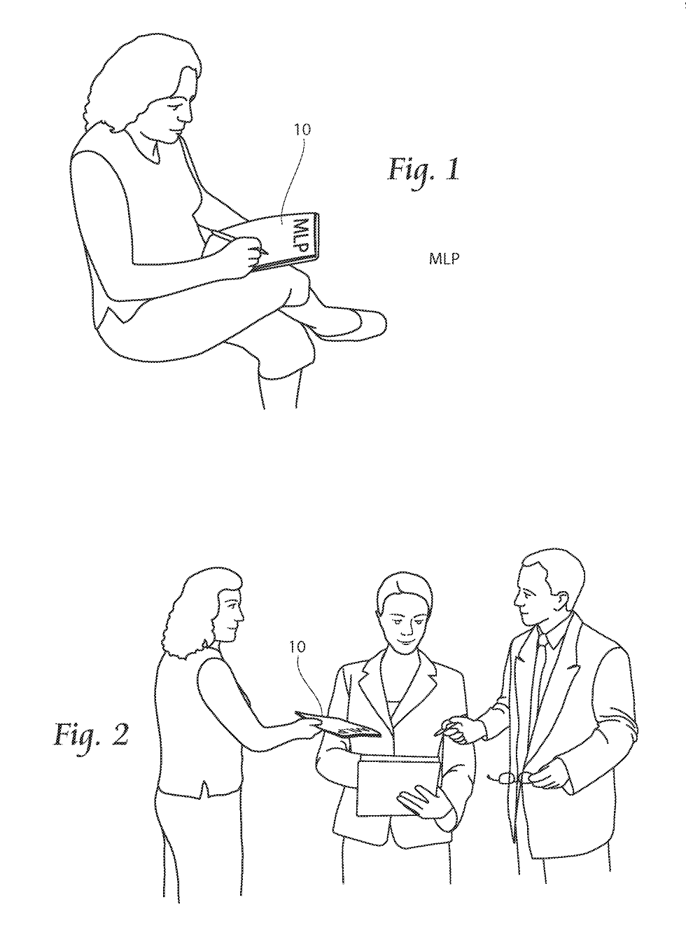

Thus, the present invention provides an efficient and effective tool for assisting a person in communicating needs and wants if that person were to become critically ill and become unable to communicate for themselves. FIG. 1 demonstrates a user completing a guide 10 according to the present invention. A non-limiting example of a guide according to the present invention can be seen in Appendix A, attached. The guide 10 provides a wide range of statements directed towards quality of life outcomes, familial communications, after death requests, and personal beliefs and values. The guide 10 thereby covers a broad spectrum of life preferences and issues effectively evincing more of the user's personal preferences regarding potential outcomes than would be provided by answers to yes/no questions. The guide 10, therefore, more fully paints a picture of the personal feelings and beliefs of the assisted person, making it easier for others to fulfill the assisted person's wishes.

### Quality of Life

The present invention provides systems and methods for determining how to best assess the user's preferences with respect to quality of life issues when the user is near the end of life. The user will read and rate the statements reflecting the user's preferences regarding quality of life according to a preselected scale. Topics in this category include, but are not limited to, the user's acceptable levels regarding his or her ability to communicate, dependency on others, and the extent of medical intervention. The quality of life guide 10 provides a plurality of statements pertaining to the user's quality of life desires, thereby assisting in the method of meeting the user's desires.

For example, as noted in Appendix A, the user may rate the following statement: “I would never want to rely on someone to feed, clothe, and bathe me.” The user would then rate this statement using an included scale, such as a Likert scale, which has ratings of Strongly Agree (SSA) (1), Somewhat Agree (SA) (2), Neither Agree nor Disagree (N/N) (3), Somewhat Disagree (SD) (4), or Strongly Disagree (SSD) (5). The user may also have the option of not responding to a question by drawing a line through the numbers, indicating that the statement does not apply or that the user does not wish to respond. Other rating scales may be employed, but it is preferable that the rating scale is understood to convey agreement and/or disagreement with a certain question or statement. If the user would like to provide more details about certain responses, he may write comments in the provided comments section.

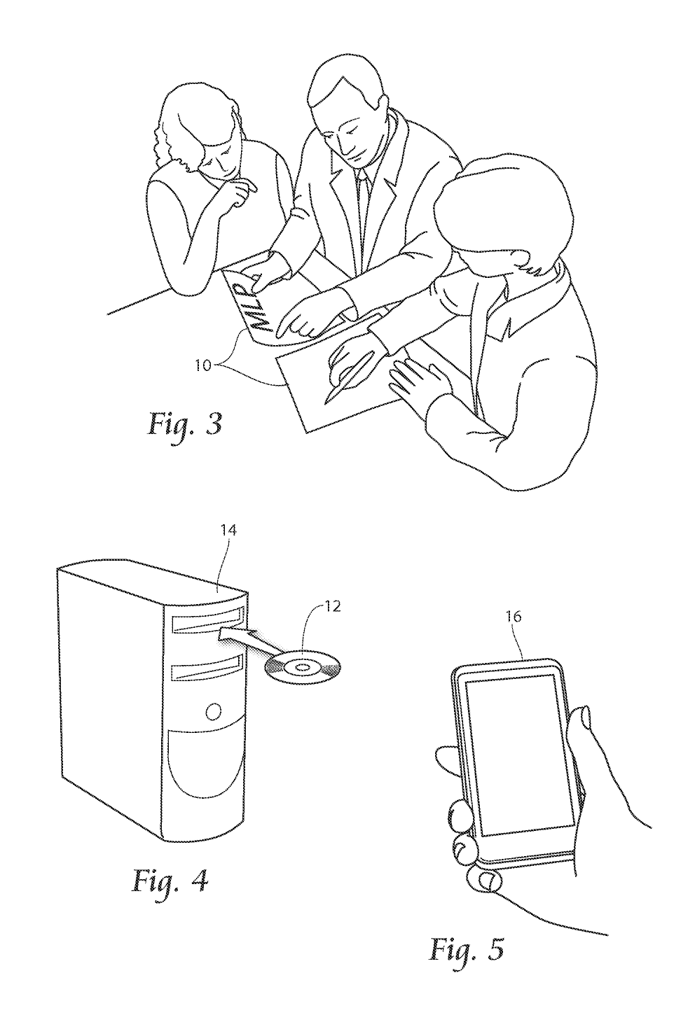

Once completed, the user will give the guide 10 with the ratings of the statements regarding quality of life to two people, or agents, that the user entrusts to act on the behalf of the user, as shown in FIG. 2. The user may elect more than two people if desired. As shown in FIG. 3, the agents further discuss the ratings and comments with respect to the user's quality of life preferences, thereby insuring that all of the parties involved will be acting in the same fashion and direction. Additionally, the agents and the user may record the discussion by any means including, but not limited to, physically taking notes by pen to paper or through a digital device, sound recording, and/or video recording. Doing so provides a record for later reference if necessary.

The in-person discussion is an important part of the invention as it promotes an open conversation about the user's wishes. It allows the agents to witness verbal and non-verbal cues which provide even more understanding. Examples consist of hand gestures, body language, voice inflections, and hesitant or emphatic responses, all of which are impossible to capture in writing, and all of which are important for effective communication. Additionally, the in-person discussion gives the agents a chance to ask questions for further clarification. All in all, the discussion of the guide 10 with the agents promotes the ultimate goal of the present invention, which is to allow the agents to make end-of-life decisions for the user as the user would if able.

An important purpose for electing at least two people is based on conferment so that the user's quality of life decision or decisions have been fulfilled. Even though the user has laid out his thoughts and beliefs thoroughly in the guide, and then later in the discussion with the agents, the judgment calls that must be made at the time of need may still be too difficult for one person to make alone, whereas two people can discuss more fully and act more clearly upon the sentiment and thoughts of the user as they are laid out in the guide 10 and as they were discussed in the meeting.

The guide 10, containing the ratings and comments with respect to the user's quality of life preferences, can be used and stored on various types of media. For example, FIG. 4 shows the guide 10 being stored on a computer readable disk 12, which can be downloaded to another computer 14, or distributed to the people discussed with respect to FIG. 2 so that they may have a digital copy of the guide 10.

FIG. 5 demonstrates the user completing the guide 10 with statements reflecting the user's preferences with respect to his personal beliefs and values on a handheld device 16, such as a Smartphone or other programmable device. The use of such a device may allow the user to provide updates and changes to the selected people so that they may better carry out the wishes of the user.

Thus, the guide provides a useful tool in recording the user's desires and requirements with respect to quality of life preferences, as well as assisting in the method for carrying out the user's desires.

### Familial Communications

The present invention provides systems and methods for determining how to best assess the user's preferences with respect to familial communications when the user is near death according to a preselected scale. Topics in this category include, but are not limited to, the user's preferences as they pertain to openness of communication regarding prognosis and last moment requests, and after death requests like organ donation and funeral preferences. The familial communications guide 10 provides a plurality of questions pertaining to the user's familial desires, thereby assisting in the method of meeting the user's desires.

For example, as noted in Appendix A, the user may rate the following statement: “My family and friends are important to me. As long as the prognosis indicates I will be able to interact with them, I want to use all medical means to restore that ability.” The user would then rate this statement using an included scale, such as a Likert scale, which has ratings of Strongly Agree (SSA) (1), Somewhat Agree (SA) (2), Neither Agree nor Disagree (N/N) (3), Somewhat Disagree (SD) (4), or Strongly Disagree (SSD) (5). The user may also have the option of not responding to a question by drawing a line through the numbers, indicating that the statement does not apply or that the user does not wish to respond. Other rating scales may be employed, but it is preferable that the rating scale is understood to convey agreement and/or disagreement with a certain question or statement. If the user would like to provide more details about certain responses, he may write comments in the provided comments section.

Once completed, the user will give the guide 10 with the ratings of the statements regarding familial communication to two people, or agents, that the user entrusts to act on the behalf of the user, as shown in FIG. 2. The user may elect more than two people if desired. As shown in FIG. 3, the agents further discuss the ratings and comments with respect to the user's familial communication, thereby insuring that all of parties involved will be acting in the same fashion and direction. Additionally, the agents and the user may record the discussion by any means including, but not limited to, physically taking notes by pen to paper or through a digital device, sound recording, and/or video recording. Doing so provides a record for later reference if necessary.

The in-person discussion is an important part of the invention as it promotes an open conversation about the user's wishes. It allows the agents to witness verbal and non-verbal cues which provide even more understanding. Examples consist of hand gestures, body language, voice inflections, and hesitant or emphatic responses, all of which are impossible to capture in writing, and all of which are important for effective communication. Additionally, the in-person discussion gives the agents a chance to ask questions for further clarification. All in all, the discussion of the guide 10 with the agents promotes the ultimate goal of the present invention, which is to allow the agents to make end-of-life decisions for the user as the user would if able.

An important purpose for electing at least two people is based on conferment so that the user's familial decision or decisions have been fulfilled. Even though the user has laid out his thoughts and beliefs thoroughly in the guide, and then later in the discussion with the agents, the judgment calls that must be made at the time of need may still be too difficult for one person to make alone, whereas two people can discuss more fully and act more clearly upon the sentiment and thoughts of the user as they are laid out in the guide 10 and as they were discussed in the meeting.

The guide 10, containing the ratings and comments with respect to the user's quality of life preferences, can be used and stored on various types of media. For example, FIG. 4 shows the guide 10 being stored on a computer readable disk 12, which can be downloaded to another computer 14, or distributed to the people discussed with respect to FIG. 2 so that they may have a digital copy of the guide 10.

FIG. 5 demonstrates the user completing the guide 10 with statements reflecting the user's preferences with respect to his personal beliefs and values on a handheld device 16, such as a Smartphone or other programmable device. The use of such a device may allow the user to provide updates and changes to the selected people so that they may better carry out the wishes of the user.

Thus, the guide provides a useful tool in recording the user's desires and requirements with respect to family communication, as well as assisting in the method for carrying out the user's desires.

### Personal Beliefs and Values

The present invention provides a personal beliefs and values guide 10 to assist in making end of life determinations for a user. A user will read and rate the statements reflecting the user's preferences regarding personal beliefs and values according to a preselected scale. Topics in this category include, but are not limited to, the user's preferences as they pertain to life support and religious assistance.

For example, as noted in Appendix A, the user may rate the following statement: “I do not wish to donate any part of my body when I die.” The user would then rate this statement using an included scale, such as a Likert scale, which has ratings of Strongly Agree (SSA) (1), Somewhat Agree (SA) (2), Neither Agree nor Disagree (N/N) (3), Somewhat Disagree (SD) (4), or Strongly Disagree (SSD) (5). The user may also have the option of not responding to a question by drawing a line through the numbers, indicating that the statement does not apply or that the user does not wish to respond. Other rating scales may be employed, but it is preferable that the rating scale is understood to convey agreement and/or disagreement with a certain question or statement. If the user would like to provide more details about certain responses, he may write comments in the provided comments section.

Once completed, the user will give the guide 10 with the ratings of the statements regarding personal beliefs and values to two people, or agents, that the user entrusts to act on the behalf of the user, as shown in FIG. 2. The user may elect more than two people if desired. As shown in FIG. 3, the agents further discuss the ratings and comments with respect to the user's personal beliefs and values, thereby insuring that all of parties involved will be acting in the same fashion and direction. Additionally, the agents and the user may record the discussion by any means including, but not limited to, physically taking notes by pen to paper or through a digital device, sound recording, and/or video recording. Doing so provides a record for later reference if necessary.

The in-person discussion is an important part of the invention as it promotes an open conversation about the user's wishes. It allows the agents to witness verbal and non-verbal cues which provide even more understanding. Examples consist of hand gestures, body language, voice inflections, and hesitant or emphatic responses, all of which are impossible to capture in writing, and all of which are important for effective communication. Additionally, the in-person discussion gives the agents a chance to ask questions for further clarification. All in all, the discussion of the guide 10 with the agents promotes the ultimate goal of the present invention, which is to allow the agents to make end-of-life decisions for the user as the user would if able.

An important purpose for electing at least two people is based on conferment so that the user's familial decision or decisions have been fulfilled. Even though the user has laid out his thoughts and beliefs thoroughly in the guide, and then later in the discussion with the agents, the judgment calls that must be made at the time of need may still be too difficult for one person to make alone, whereas two people can discuss more fully and act more clearly upon the sentiment and thoughts of the user as they are laid out in the guide 10 and as they were discussed in the meeting.

The guide 10, containing the ratings and comments with respect to the user's personal beliefs and values, can be used and stored on various types of media. For example, FIG. 4 shows the guide 10 being stored on a computer readable disk 12, which can be downloaded to another computer 14, or distributed to the people discussed with respect to FIG. 2 so that they may have a digital copy of the guide 10.

FIG. 5 demonstrates the user completing the guide 10 with statements reflecting the user's preferences with respect to his personal beliefs and values on a handheld device 16, such as a Smartphone or other programmable device. The use of such a device may allow the user to provide updates and changes to the selected people so that they may better carry out the wishes of the user.

Thus, the guide provides a useful tool in recording the user's desires and requirements with respect to the user's beliefs and values, as well as assisting in the method for carrying out the user's desires.

The guide of the present invention assists in carrying out the methods of the present invention. That is, the guide is used in a method of communicating end of life decisions of the user to a third party. The method generally consists of providing a guide, completing the guide, discussing the guide with at least two people simultaneously, recording the results, and then having the results conveyed to a third party care giver or medical practitioner. The method may have the user assess topics related to personal values, familial communications, or quality of life requirements, or the method may include two or more of these categories. Furthermore, each of these categories will preferably include multiple questions and/or statements related to the categories, thereby providing a more solidified framework for the user's wishes to be carried.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

I/We claim:

1. A system for determining a user's personal end-of-life care preferences based on potential outcomes, the system comprising:
a guide having a plurality of preselected categories, each category having a plurality of statements;
a scale for rating the user's personal preference for each statement;
a means to input the user's rating of each statement; and
a means to store the guide;
wherein the statements in a category are designed to provide results that determine the user's personal end-of-life preferences.

2. The guide according to claim 1, wherein one preselected category is directed towards the quality of life for the user at the end-of-life.

3. The guide according to claim 1, wherein one preselected category is familial communications with the user at the end-of-life.

4. The guide according to claim 1, wherein one preselected category is personal beliefs and values for the user at the end-of-life.

5. The guide according to claim 1, wherein the scale is a Likert scale.

6. The system as claimed in claim 1, wherein the means to input the user's ratings is a computer.

7. The system according to claim 1, wherein the means to input the user's ratings is a handheld device.

8. The system according to claim 1, wherein the means to store the guide is a computer.

9. The system according to claim 1, wherein the means to store the guide is a handheld device.

10. A method for determining a user's personal end-of-life care preferences based on potential outcomes, the method comprising the steps of:
a) providing a guide having a plurality of preselected categories, each category having a plurality of statements, and a scale for which the user may rate each statement based on the personal preferences of the user;
b) distributing the user ratings to at least two user selected agents; and
c) discussing the user ratings with the at least two user selected agents,
d) wherein a guideline is established for fulfilling the user's end of life needs.

11. The method according to claim 10, wherein one preselected category is quality of life for the user at the end-of-life.

12. The method according to claim 10, wherein one preselected category is familial communications and after death requests for the user at the end-of-life.

13. The method according to claim 10, wherein one preselected category is personal beliefs and values for the user at the end-of-life.

14. The method according to claim 10, wherein the scale is similar to a Likert scale.

15. The method according to claim 10, wherein the plurality of statements in each category include opposing language.

16. The method according to claim 10, wherein the storage device a computer.

17. The method according to claim 10, wherein the storage device a handheld device.

18. The method of claim 10 further comprising the step of conveying the guideline to a third party to provide assistance to the third party to meet the user's wishes.

19. The method according to claim 10, wherein the guide is discussed with the user selected agents simultaneously.

20. A method of using the system of claim 1.
